(19) United States
(12) Patent Application Publication
(10) Pub. No.: US 2020/0317119 A1
(43) Pub. Date: Oct. 8, 2020

(54) AUTONOMOUS VEHICLE ACTIVE INTERACTION WITH SURROUNDING ENVIRONMENT

(71) Applicant: SF Motors, Inc., Santa Clara, CA (US)

(72) Inventors: Ke Huang, Santa Clara, CA (US); Fan Wang, Santa Clara, CA (US)

(73) Assignee: SF Motors, Inc., Santa Clara, CA (US)

(21) Appl. No.: 16/378,475

(22) Filed: Apr. 8, 2019

(51) Int. Cl. B60Q 1/50; B60Q 1/34; B60Q 5/00; B60W 30/095

(52) U.S. Cl. CPC B60Q 1/50; B60W 30/0956; B60Q 5/006; B60Q 1/346

(57) ABSTRACT

An automated vehicle (AV) which automatically interacts with objects in a surrounding environment based on the objects determined intention and predicted actions determined based on their intention. Data is collected from an external environment by cameras, sensors, and optionally other devices on an AV. The data is processed to identify objects and a state for each object, and an interaction scenario is identified. For objects within the interaction scenario, an intention for each object is determined, and the action of the object is predicted. The AV generates a decision to perform an action to communicate the AV's action to one or more objects. Commands are generated to execute the decision, and the intention of the AV is implemented by executing the commands using one or more output mechanisms (horn, turn signal, display, and/or other mechanisms) for the

AV.

### BACKGROUND

Human drivers can communicate and negotiate with objects in the environment they are driving in, including pedestrians, bicycles, and vehicles on the road when such communications are needed. For example, a human driver of a vehicle can stop at a road intersection and gesture to pedestrians his/her willingness to yield right of way by waving a hand, let bicycles on the right pass the vehicle before the vehicle makes a right turn, or gesture to other drivers at a four-way stop intersection.

However, in autonomous vehicles, the driver becomes a passenger and does not make decisions. Furthermore, autonomous vehicles are not currently equipped with any means of communicating complex human-like intentions to other drivers and pedestrians interactively. What is needed is improved interaction between an autonomous vehicle and the surrounding environment.

### SUMMARY

The present technology, roughly described, includes an automated vehicle (AV) which automatically interacts with objects in a surrounding environment based on the objects determined intention and predicted actions determined based on their intention. Data is collected from an external environment by cameras, sensors, and optionally other devices on an AV. The data is processed to identify objects and a state for each object, and an interaction scenario is identified based on the object type and object monitoring data. For objects within the interaction scenario, an intention for each object is determined, and the action of the object is predicted based on the object intention and object state. The AV generates a decision to perform an action to communicate the AV's intention to one or more objects, the decision generated based on the predicted object action. Commands are generated to execute the decision, and the intention of the AV is implemented by executing the commands using one or more output mechanisms (horn, turn signal, display, and/or other mechanisms) for the AV.

In some instances, an autonomous vehicle system automatically interacts with a surrounding environment. The system includes a data processing with one or more processors, a memory, a planning module, and a control module. The data processing system detects, from received sensor data, an object in an interaction scenario in an external environment. The data processing system also monitors the object in response to the detected interaction scenario. The system can determine an intention for the object within the external environment based on the monitoring, and the system can generate one or more commands to indicate an intention of the autonomous vehicle in response to the determined intended action of the object.

In some instances, the present technology includes a method for automatically interacting with a surrounding environment by an autonomous vehicle. The method includes detecting, by a data processing system from received sensor data, an object in an interaction scenario in an external environment. The object is monitored in response to the detected interaction scenario. An intention is determined for the object within the external environment based on the monitoring. One or more commands is generated to indicate an intention of the autonomous vehicle in response to the determined intended action of the object.

In some instances, a non-transitory computer readable storage medium includes embodied thereon a program, wherein the program is executable by a processor to perform a method for automatically interacting with a surrounding environment by an autonomous vehicle. The method includes detecting, by a data processing system from received sensor data, an object in an interaction scenario in an external environment. The object is monitored in response to the detected interaction scenario. An intention is determined for the object within the external environment based on the monitoring. generating One or more commands is generated to indicate an intention of the autonomous vehicle in response to the determined intended action of the object.

Additional objects, advantages, and novel features of the examples will be set forth in part in the description which follows, and in part will become apparent to those skilled in the art upon examination of the following description and the accompanying drawings or can be learned by production or operation of the examples. The objects and advantages of the concepts can be realized and attained by means of the methodologies, instrumentalities and combinations particularly pointed out in the appended claims.

### BRIEF DESCRIPTION OF FIGURES

FIG. 1 illustrates an environment within which a system and method for automatically interacting with a surrounding environment by an autonomous vehicle can be implemented, in accordance with an example embodiment.

FIG. 2 illustrates another environment within which a system and method for automatically interacting with a surrounding environment by an autonomous vehicle can be implemented, in accordance with an example embodiment.

FIG. 3 is a block diagram of an autonomous vehicle, in accordance with an example embodiment.

FIG. 4 is a block diagram of a data processing system within an autonomous vehicle, in accordance with an example embodiment.

FIG. 5 is a block diagram of a system for automatically interacting with a surrounding environment by an autonomous vehicle, in accordance with an example embodiment.

FIG. 6 is a flow chart illustrating a method for automatically interacting with a surrounding environment by an autonomous vehicle, in accordance with an example embodiment.

FIG. 7 is a flow chart illustrating identifying an interaction scenario, according to an example embodiment.

FIG. 8 is a flow chart illustrating monitoring objects inside an interaction scenario, according to an example embodiment.

FIG. 9 is a flow chart illustrating predicting intended actions of objects, according to an example embodiment.

FIG. 10 is a block diagram of a computing environment for implementing a system for automatically interacting with a surrounding environment by an autonomous vehicle can be implemented, according to an example embodiment.

### DETAILED DESCRIPTION

The present technology, roughly described, includes an automated vehicle (AV) which automatically interacts with objects in a surrounding environment based on the objects' determined intention and predicted actions determined based on their intention. Data is collected from an external environment by cameras, sensors, and optionally other devices on an AV. The data is processed to identify objects and a state for each object, and an interaction scenario is identified based on the object type and object monitoring data. For objects within the interaction scenario, an intention for each object is determined, and the action of the object is predicted based on the object intention and object state. The AV generates a decision to perform an action to communicate the AV's intention to one or more objects, the decision generated based on the predicted object action. Commands are generated to execute the decision, and the intention of the AV is implemented by executing the commands using one or more output mechanisms (horn, turn signal, display, and/or other mechanisms) for the AV.

The technical problem addressed by the system of the presented disclosure involves automatically interacting with an environment in order to provide a safer AV. Some vehicles are able to detect other objects in their lane, for example as part of a cruise control function. However, existing systems do not interact with other objects based on the other objects' intentions.

Most conventional AVs can only use existing means for minimum, open-loop communication, such as an intention of lane change, left/right turns, and the like. The conventional AVs do not actively detect surrounding pedestrians and intentions of vehicles as it is performed by human drivers. Additionally, conventional AVs do not interact with the external environment in a closed-loop manner. In particular, to avoid incidents, an AV usually takes a wait-and-see approach, which is inefficient, especially in a busy urban environment and is not necessarily safe because it may trigger road rage and welcome targeted dangerous maneuvers from other vehicles. Furthermore, AV are ignorant of the signals from other parties sharing the road. Thus, the passengers in the AVs may not know intentions of the AVs and may feel frustrated and concerned for their safety while riding in the AVs.

The presently described AV system solves the technical problem by automatically identifying objects, interaction scenarios, and the intentions of objects within the interaction scenario, and then automatically predicts the actions of the one or more objects within the interaction scenario. The AV system then automatically determines an action for communicating an intention to the object in response or in view of the predicted action of the object. The AV then executes the automatically determined action. By automating the interaction process, the AV of the present technology provides a safer environment for surrounding objects as well as the AV itself.

The AV can communicate with other objects by signaling, via turn signals, horn, headlights, or other light sources, such as light emitting diodes (LED) displaying specific words, warning signs, and so forth.

The AV of the present technology facilitates active and intelligent closed-loop interactions with the surrounding environment. The present system automatically and significantly enhances the safety and efficiency of the AV at intersections, four-way stops, when merging into a busy lane, and so forth, as well as provides confidence to other parties who share the road and may include both human and AVs. Moreover, the system can reduce the uncertainty of data received based on the prediction and, hence, results in better decision making with respect to actions performed by the AV. Even if an attempt of interaction of the AV with other parties on the road fails, the system may still generate another interaction scenario (e.g., more conservative one), thereby improving the overall safety on the road.

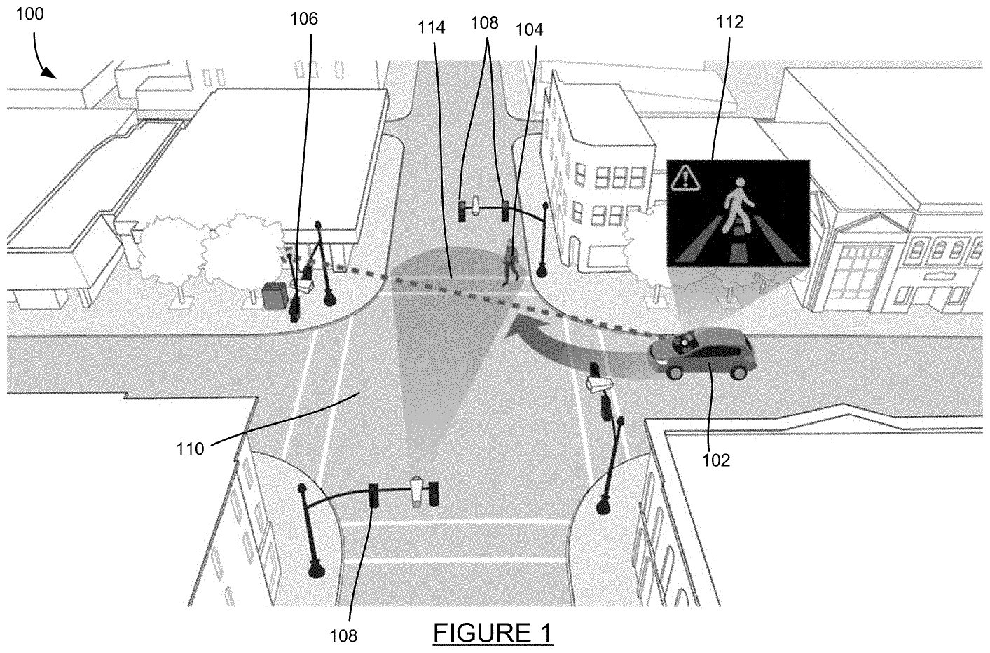

FIG. 1 illustrates an example environment 100 within which an AV can automatically interact with a surrounding environment, in accordance with some instances. The environment 100 may include an AV 102 and objects including a pedestrian 104, a traffic light 106 facing a first direction, a traffic light 108 facing a second direction, and so forth. When the AV 102 approaches an intersection 110 on a road, sensors installed on or in the AV 102 collect data regarding the environment and the objects. Based on the collected data, the AV 102 may identify a scenario 112 associated with the objects in the environment 100. The scenario 112 may include approaching and/or passing through an intersection while considering the pedestrian 104 crossing the road 114. Upon identifying the scenario 112, the AV 102 can monitor the objects within the scenario 112 to determine an intent of the objects, predict object actions based on the object intention, and generate an action for the AV to communicate an intention of the AV to the object.

The AV 102 can generate an action that communicates, to an object in the external environment, an intention of the AV 102. For example, AV 102 may determine that pedestrian 104 has an intention to travel along the crosswalk based on the direction of the pedestrian's travel, the location of the cross walk, and the absence of eye contact between the pedestrian and AV 102, and the AV can predict the pedestrian will continue crossing the street in the cross walk. The communication may indicate that the AV 102 may decide to yield the road to the pedestrian 104 before making a right turn.

AV 102 can communicate using turn signals, lights on the vehicle, audio mechanisms such as a horn or speaker, displays or panels, and other output mechanisms. In some instances, AV 102 may communicate, for example, via a panel or display which output text, graphics, gesture images, or other content related to the intended action of the AV 102. In some instances, the graphics, text, gestures or other content provided through a panel or display can include indicators that are considered the most recognizable to people and/or pedestrians in the particular environment or in a driving situation in general.

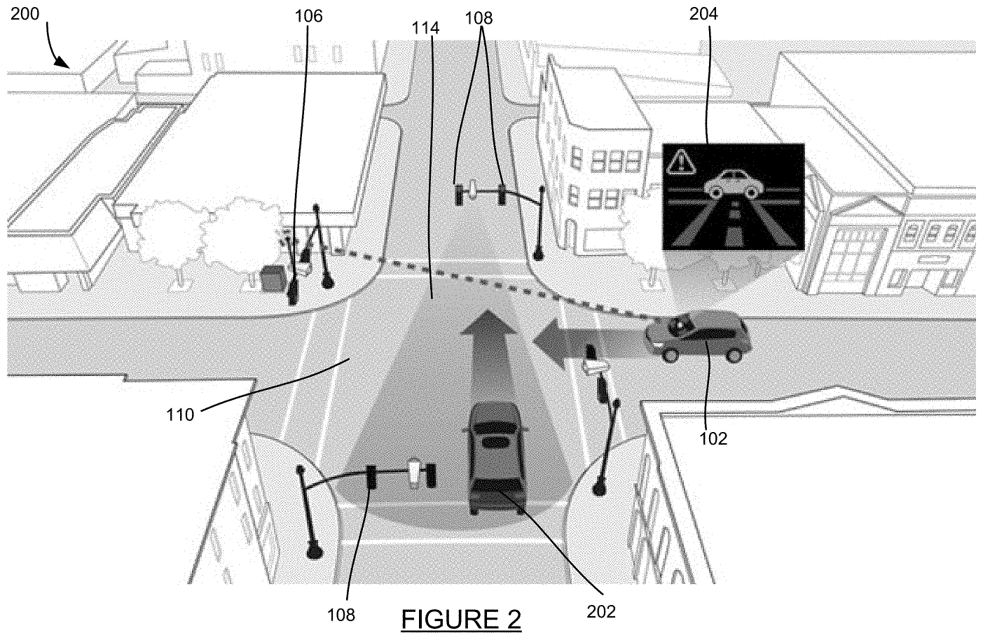

FIG. 2 illustrates another example environment 200 in which an AV can automatically interact with a surrounding environment. FIG. 2 illustrates an AV 102 and a plurality of objects. The objects may include a vehicle 202, a traffic light 106 facing a first direction, a traffic light 108 facing a second direction, and so forth. AV 102 may approach an intersection 110 and collect data associated with the objects at or near the intersection. For example, the AV 102 may detect the vehicle 202 and a current light color (red, yellow, or green) of the traffic light 106. Based on the collected data, the AV 102 may detect an interaction scenario 204 associated with the objects.

The interaction scenario 204 may include an approach to an intersection with traffic lights and the vehicle 202 traveling on road 114. Upon determining the scenario 204, the AV 102 can monitor the objects, determine object intentions from the monitoring, and predict object actions based on the object intention. For example, AV 102 can determine that vehicle 202 has an intention to continue traveling on the road perpendicular to AV 102 based on monitoring the vehicle, and predict that the vehicle will continue to travel along the road. The AV may generate a decision to communicate an intention that AV 102 will not travel through the intersection—at least while vehicle 202 is traveling through the intersection.

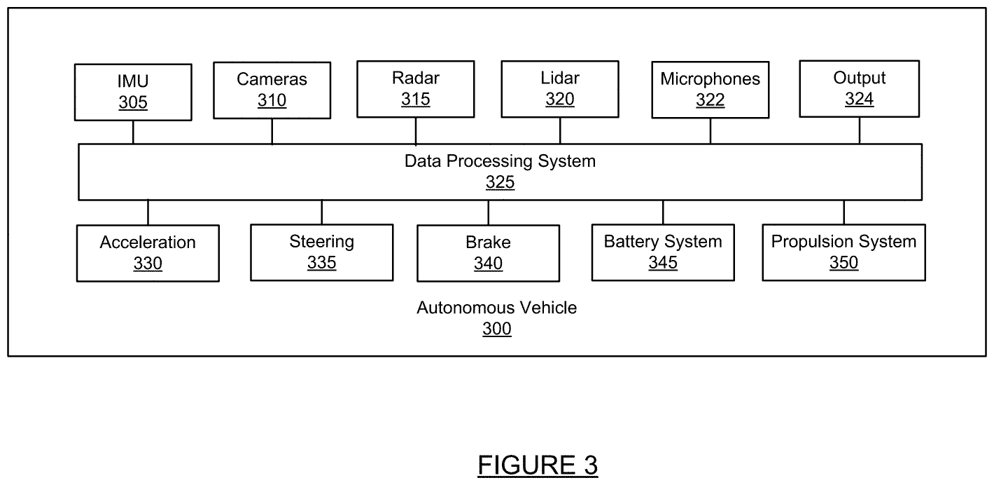

FIG. 3 is a block diagram illustrating an AV 300, according to an example embodiment. The AV 300 can include a data processing system 325 in communication with an inertia measurement unit (IMU) 305, cameras 310, radar 315, lidar 320, and microphones 322. Data processing system 325 may also communicate with acceleration 330, steering 335, breaks 340, battery system 345, and propulsion system 350. The data processing system 325 and the components it communicates with are intended to be exemplary for purposes of discussion. It is not intended to be limiting, and additional elements of an AV can be implemented in a system of the present technology, as will be understood by those of ordinary skill in the art.

IMU 305 may track and measure the AV acceleration, yaw rate, and other measurements and provide that data to data processing system 325 as well as other components in AV 200.

Cameras 310, radar 315, lidar 320, and microphones 322 may form all or part of a perception module of the AV 300. The AV 300 may include one or more cameras 310 to capture visual data inside and outside of the AV 300. On the outside of the AV 300, multiple cameras can be implemented. For example, cameras on the outside of the AV 300 may capture a forward-facing view, a rear-facing view, and optionally other views. Images from the cameras can be processed to detect objects such as streetlights, stop signs, lines or borders of one or more lanes of a road, and other aspects of the environment for which an image can be used to better ascertain the nature of an object than radar. To detect the objects, pixels of images can be processed to recognize objects and singular images and series of images. The processing can be performed by image and video detection algorithms, machine learning models, computer vision techniques, deep learning techniques, and other algorithms which operate to detect particular objects of interest, as well as other object detection techniques.

Radar 315 may include multiple radar sensing systems and devices to detect objects around the AV 300. In some instances, a radar system can be implemented at one or more of each of the four corners of the AV 300, on the front side of the AV 300, on the rear side of the AV 300, and on the left side and right side of the AV 300. Lidar 320 can be used to detect objects in adjacent lanes, as well as in front of and behind the AV 300. The radar and lidar sensors can be used to detect stationary and moving objects in adjacent lanes as well as in the current lane in front of and behind the AV 300.

Output mechanisms 324 may include one or more mechanisms that provide an output from AV 300. The output mechanisms 324 may include one or more of external turn signals, a horn, lighting on the exterior of AV 300, LED display or other display suitable for displaying text, video, and other visual content for communicating an intention, message, or other content. The output mechanism can be used to communicate an intention in response to determining an object's intention as part of an interactive scenario.

Data processing system 325 may include one or more processors, memory, and instructions stored in memory and executable by the one or more processors to perform the functionality described herein. In some instances, the data processing system 325 may include a planning module, control module, and drive by wire (DBW) module. The modules can communicate with each other to receive raw and processed data, a perception module, determine an object intention, predict an object action, generate a decision for the AV, and generate commands to execute the generated decision.

Acceleration 330 may receive commands from the data processing system to accelerate. Acceleration 330 can be implemented as one or more mechanisms to apply acceleration to the propulsion system 350. Steering module 335 controls the steering of the AV 300, and may receive commands to steer the AV 300 from data processing system 335. Brake system 340 may handle braking applied to the wheels of the AV 300, and may receive commands from data processing system 325. Battery system 345 may include a battery, charging control, battery management system, and other modules and components related to a battery system on the AV 300. Propulsion system 350 may manage and control propulsion of the AV 300, and may include components of a combustion engine, electric motor, drivetrain, and other components of a propulsion system utilizing an electric motor with or without a combustion engine.

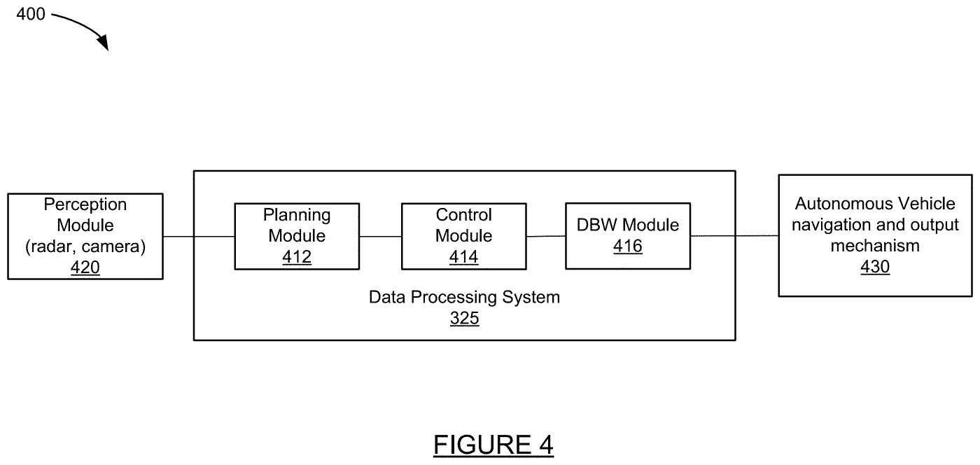

FIG. 4 is a block diagram 400 of a data processing system of an AV. The data processing system 325 may receive data and information from perception module 420. Perception module 420 can be in communication with a plurality of sensors installed in or on the AV 300. The sensors may include a radar, lidar, microphone, and camera elements, as well as logic for processing the sensor output. The perception module can identify objects of interest, object location, speed, and acceleration, and object gestures, if any, and provide the data to planning module 412.

Planning module 412 may receive and process data and information received from the perception module 420 to plan actions for the AV. The action planning may include determining an interaction scenario, an object intention, predicting an object action, and generating a decision for an action in response to the object's predicted action. Planning module 412 can generate an action for communicating an intention of the AV, such as for example an intention to navigate along a trajectory of the AV 300, and navigate the AV 300 according to the trajectory, for example, from a current lane to the adjacent lane. Planning module 412 may generate samples of trajectories between two lines or points, analyze and select the best trajectory, and provide the best trajectory for navigating from one point to another for control module 414. Planning module can also generate actions which indicate intentions to objects in an environment of the AV, such as for example turn signals, messages, and other content.

Control module 414 may receive information from the planning module 412, such as a selected trajectory over which a lane change should be navigated, an action to communicate an intention, or another action. Control module 414 may generate commands to execute the action, such as for example to navigate the selected trajectory. The commands may include instructions for performing the action, such as for example accelerating, braking, and turning the AV to effectuate navigation along the selected trajectory, activating a turn signal, displaying a message, and so forth.

Drive-by-wire (DBW) module 416 may receive the commands from control module 414 and actuate navigation components and output mechanisms of the AV based on the commands. In particular, DBW module 416 may control the accelerator, steering wheel, brakes, and output mechanisms such as turn signals, lights, displays and/or panels, speakers.

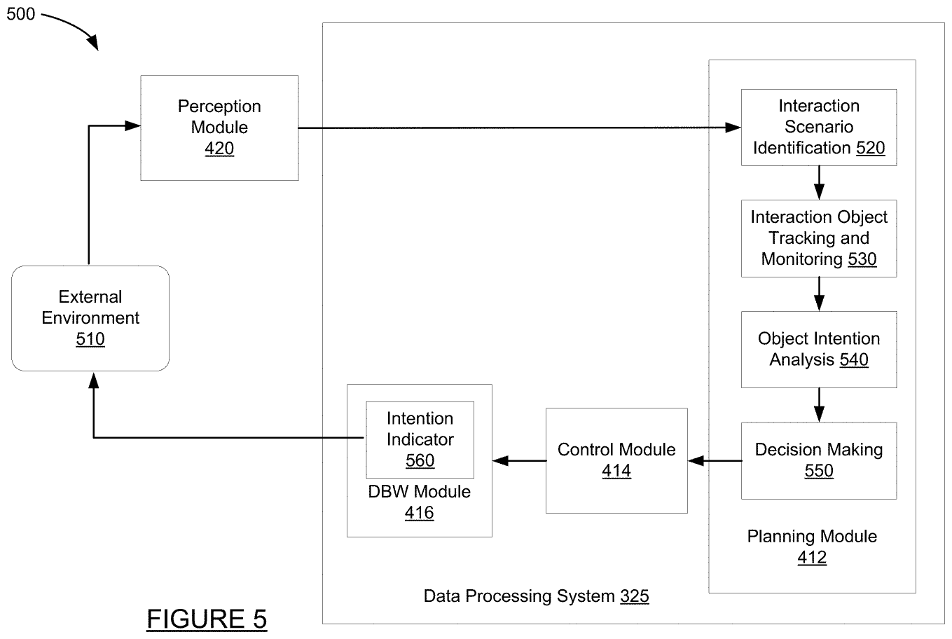

FIG. 5 is a block diagram of a system 500 for automatically interacting with a surrounding environment by an AV. The system 500 can be implemented in an AV and provides more details for a planning module, control module, and DBW module of an AV. The system 500 may include a perception module 420 and a data processing system 325. The perception module 420 can include at least one or more cameras, such as for example a front HD camera, lidar, radar, ultrasound sensors, infra-red sensors, microphones, and so forth.

In some instances, the planning module 412, the control module 414, and the DBW module 416 of the data processing system 325 as well as perception module 420 create a closed loop with an external environment 510. The closed loop is made up from the external environment being captured by the perception module, perception data being provided by the perception model to the planning module, and the planning module provides a decision based on the perception data to the control module. The control module generates commands for the DBW module 416 to implement the decision, and the external environment responds to the implementation, which is again captured by the perception module.

The perception module 420 may collect data associated with the external environment 510. Based on the collected data, the perception module 420 may detect objects in the external environment 510. In some instances, the objects may include one or more pedestrians, vehicles, bicycles, motorcycles, and any other object in an external environment 480.

The perception module 420 receives the data from the sensors that capture data from the external environment (lidar, radar, ultrasound, camera, other sensors). The sensor data may include one or more of the following: a vehicle location, speed, and acceleration, a pedestrian location, speed, acceleration and gesture, and a location, speed, and acceleration of another type of object such as a bicycle, stroller, scooter, or other object.

In some instances, the collected data may include semantic information to describe the external environment 510. In some instances, semantic information may include an identifier of the data, for example, a phrase “objects on road.” The semantic information can be provided in a form of a word or a sign (e.g., “cross” for a pedestrian crossing a street). The semantic information is provided to planning module 412.

The planning module 412 may include an interaction scenario identification module 520. Interaction scenario identification 520 can identify an object type, e.g., a pedestrian, a group of pedestrians, a vehicle, a group of vehicles, a bicycle, and so forth, and process perception data to track each identified object having an object type. In some instances, interaction scenario identification 520 can detect an interaction scenario based on the object type and object tracking data, and each object can be associated with its own interaction scenario.

Upon detection of an interaction scenario, interaction object tracking and monitoring module 530 can monitor one or more objects associated with an interaction scenario. The interaction object tracking and monitoring module 530, while monitoring objects within an interaction scenario, can identify gestures, if any, made by objects such as pedestrians and identify object states. Based on the data collected from the monitoring, object intention analysis module 540 can determine an object intent for each of the one or more objects within the intention scenario based on the object state, detected gestures, and object tracking information. The object gestures can include detecting that a pedestrian is touching a traffic light button and wants to cross the road, the pedestrian is waving to the AV to indicate that the pedestrian yields to the AV, eye contact between the pedestrian and sensors of the AV, absence of the eye contact being an indication that the pedestrian does not see the AV, body motion and other detected gestures of the object. Predicted actions of an object can include crossing a road by a pedestrian, crossing an intersection by a vehicle, leaving a lane by a vehicle, overtaking a vehicle on a road, cutting in front of another vehicle by a vehicle, and other gestures.

Based on the determined object intention, decision making module 550 can predict an object action and generate a decision to take an action to communicate to one or more objects in an external environment.

Once a decision has been generated, the decision is transmitted to control module 414 which then generates commands to implement the action. The commands are then provided to DBW module 416 which actuates the commands. An intention indicator 560 within DBW module 416 can communicate the intention of the AV via one or more of a visual indication, an audio indication, a Vehicle-to-everything (V2X) communication, and so forth.

The system 500 can continuously collect data, process data, and generate decisions based on the processed data in real-time. The perception module 420 can be further configured to receive feedback from one or more objects in response to communicating the intention. The planning module 412 may adjust the intention, or communicate other intentions, based on the feedback received by the perception module 420.

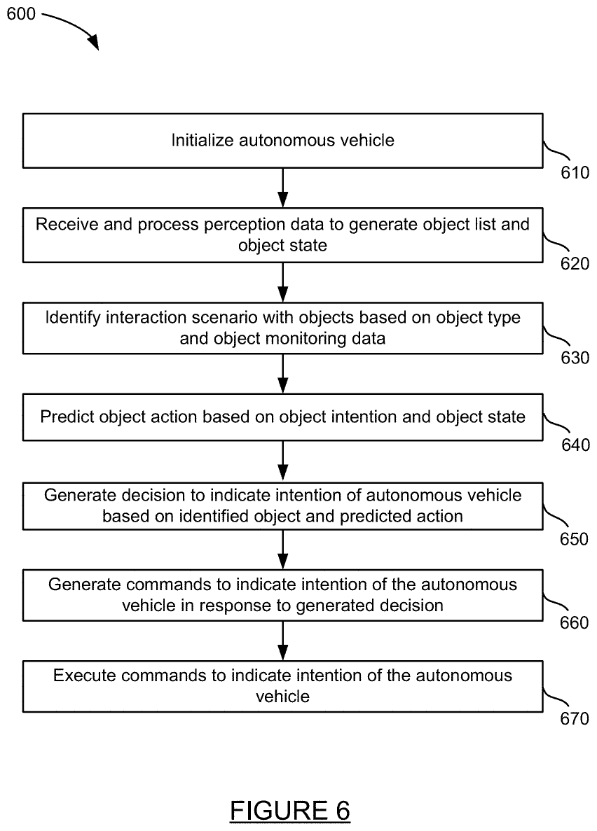

FIG. 6 is a flow chart illustrating a method 600 for automatically interacting with a surrounding environment by an AV.

An AV is initialized at step 610. Initializing the AV may include starting the AV, performing an initial system check, calibrating the AV to the current ambient temperature and weather, loading passenger and/or other preferences and settings, and calibrating any systems as needed at startup.

Data can be received from one or more AV sensors and processed by a perception module at step 620. The data may include image data from one or more cameras, data received from one or more sensors such as radar, lidar, ultrasound, and UV sensors, audio data from microphones, and other data. The received data can be processed to detect lanes in a road currently traveled by the AV, one or more classified object lists, and associated object states. In some instances, an object detected by the perception module can be classified as a vehicle. In some instances, the data can be associated with another object type, such as a pedestrian, a vehicle, and any other object in an external environment surrounding the AV. The collected data may include object location, speed, and acceleration of the pedestrian, indicators on a vehicle object, a color of traffic lights in the external environment, and so forth. In an example embodiment, the data may also include semantic information, such as for example the word “cross” or “stop” or “waving,” to describe an external environment.

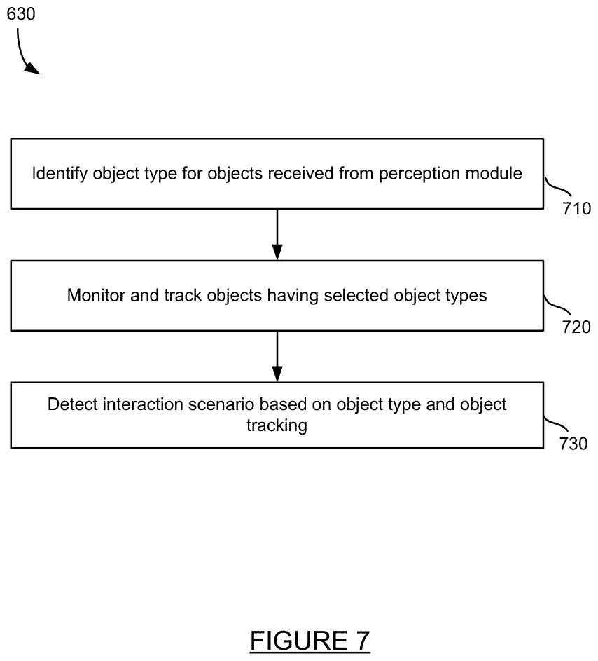

An interaction scenario is identified at step 630. The interaction scenario can be detected with objects based on object type and object monitoring data. The objects associated with the identified interaction scenario may subsequently be subject to a communication of the AV's intention. Operation 630 of the method 600 is described in more detail with reference to FIG. 7.

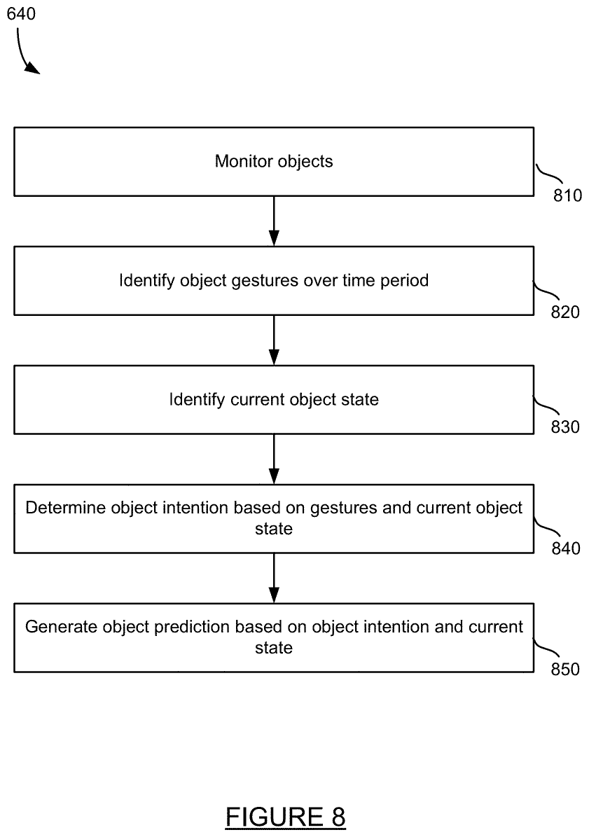

An object action is predicted based on an object intention and an object state at 640. Generating a prediction may include monitoring objects within an interaction scenario over time, identifying object gestures detected during that time, and identifying the current object state at the time the prediction is made. An object intention is then determined based on gestures and the current object state and the object prediction is then determined based on the object intention and current state. More detail for determining an object prediction based on an object intention is discussed with respect to the method of FIG. 8.

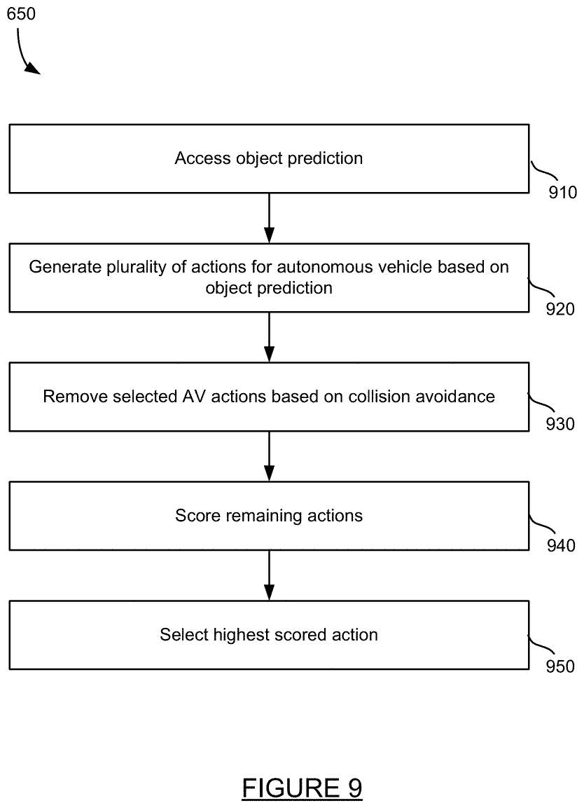

A decision to indicate the intention of the AV is generated at step 650. The decision can be based on an identified object and a predicted action of the AV. generating a decision to indicate an intention may include generating a plurality of actions, performing a collision avoidance analysis on the generated actions, scoring the remaining actions, and selecting the highest court action as a decision to perform. Generating a decision is discussed in more detail with respect to the method of FIG. 9.

Commands are generated to indicate the intention of the AV based on the generated decision at operation 660. The commands can be used to execute the generated decision to indicate the intention of the AV. The intention of the AV can be signaled to the objects via a display of text, graphics, gestures, and other content, one or more lights (e.g., turn signals, headlight), an audio indication (e.g., a horn), and a V2X communication (e.g., an electronic board on the AV with a warning or indication displayed on the electronic board). In some instances, the AV intention is communicated with an object such as a pedestrian using indicators that are considered to be most recognizable to people. The commands to indicate intention of the AV are executed at step 670. Execution may include having an intention indicator 560 of the DBW module 416 actuate the commands through one or more of turn signals, lights, a panel a display, as well as acceleration, breaking, turning, and any other communication or physical AV controls.

FIG. 7 is a method for detecting an interaction scenario. The method of FIG. 7 provides more detail for step 630 of the method of FIG. 6. First, an object type for objects received from a perception module is identified at step 710. The object type may be identified as objects of interest to the AV, such as for example a pedestrian, vehicle, stop light, crosswalk, bicycle being written by a user, and other objects that may affect the trajectory or actions of the AV.

Objects having selected object types are monitored and tracked at step 720. Object types which may be selected to be monitored and tracked include pedestrians, emergency workers (police men, fireman), vehicles, moving bicycles, and other objects that may affect the trajectory or actions of the AV.

Interaction scenario may be determined based on the object type and object tracking at step 730. An interaction scenario is a recognized state of the external environment in which there may be a benefit for the AV to communicate with an object within the external environment. In an interaction scenario can be based on an object type, in particular an object that may affect a trajectory or action of the AV, and object tracking that reveals a particular objects trajectory or location may affect the trajectory or actions of the AV. In some instances, an object may affect the trajectory or actions of the AV if the object is within a threshold distance of the AV, is a particular type of object such as a pedestrian or vehicle, is on a trajectory to intersect with the trajectory of the AV, was otherwise determined to be a relevant object with respect to the AV. Detecting an interaction scenario may include setting a flag having a parameter of one or more of object types and object identifiers to associate a particular object with the particular interaction scenario.

FIG. 8 is a method for predicting an object action. The method of FIG. 8 provides more detail for step 640 of the method of FIG. 6. First, objects are monitored at step 810. The object may be monitored by sensors, including cameras, positioned in or on the AV. Objects may be monitored for a plurality of cycles, in some instances for up to 10 seconds or longer.

Object gestures are identified for objects being monitored at step 820. As objects are being monitored over time, the AV sensors may identify gestures made by an object. For example, gestures such as waving a vehicle forward, showing a vehicle a hand in a stop motion, making eye contact or not making eye contact in a general direction of an AV, providing a gesture showing frustration, and other gestures may be detected by the system of the AV.

A current object state is identified at step 830. The object state may include information about an object, including a current location, velocity, and acceleration, as well as an indication of what the object is doing. The indication of what the object is doing may be recorded as semantic information, such as for example “cross” when crossing the street, “walk” when a pedestrian is walking, “riding” when a cyclist is riding a bike, “stopped” when a pedestrian is stopped at a corner of a street, and so forth. The current object state can include the current location, for example in GPS coordinates, velocity, acceleration, and an indication what the object is doing in the present processing cycle.

A determination is made as to an object intention based on gestures and current object state at step 840. Gestures may be determined by one or more images captured of the object over a period of time and analyzed by the data processing system of the present technology. In some instances, analyzing images to determine a gesture may be performed by neural networks, image processing engines, and other software and/or hardware, including machine learning software, that specializes in recognizing objects within an image. The gestures may include a pedestrian holding a hand out to indicate a vehicle should stop, reaching to press a crosswalk button on a pole at a corner of an intersection, making eye contact with a vehicle or not making eye contact with a vehicle, and other gestures. In some instances, a gesture may be one or more physical movements, either stationary or in motion, by a person.

An intention may be determined based on a gesture and the current object state. In some instances, an intention can be determined as one of several action descriptors that are suggested by both a gesture and a current object state. For example, if a gesture is a user not making eye contact with the AV, and the object state indicates the user walking towards a crosswalk, then the objects to intention can be determined to be that the user intends to walk through a crosswalk without stopping for the AV. If a gesture consists of a pedestrian object waving to the AV is detected along with an object state of the pedestrian coming to a stop at a sidewalk in front of a crosswalk, the pedestrian object intention may be determined to be that the pedestrian will wait on the sidewalk for AV to continue. In some instances, an object intention can be based on either a gesture or a common object state. For example, if a pedestrian object is detected to have a gesture of waving an AV to continue while the pedestrian object state indicates the user is continually walking into the street in the AV's path, then the gesture and the object state do not suggest the same intention. In this instance, a data processing system can determine a safer intention that the user intends to cross the street at a crosswalk per the pedestrian object state rather than determine an intention that the pedestrian intends to wait for the AV to pass as suggested by the gesture.

An object prediction is generated based on the object intention in the current state at step 850. The object prediction may be an extension of the objects intention but is extrapolated or extended for a certain time period into the future. For example, if an objects intention is determined to be that the object is about to cross a street, the prediction for the object will be the object's physical location at certain time intervals for a period of time. The location, in some instances, can be determined from the object's current location, velocity, and acceleration, and extrapolated based on the objects current disposition and direction of travel as determined from the monitoring performed at step 810. In some instances, actions of an object can be predicted for a time period of up to 5 seconds, 10 seconds, or some other period of time.

FIG. 9 is a method for generating a decision to indicate an intention of an AV. The method of FIG. 9 provides more detail for step 650 of the method of FIG. 6. First, an object prediction is accessed at step 910. The prediction is performed as part of the method of FIG. 8.

Next, a plurality of actions for the autonomous vehicle are generated based on the object prediction at step 920. For example, if the object prediction is that a pedestrian object will be navigating through a crosswalk in front of the AV, the plurality of actions may include different samplings of navigating the AV to a stop before reaching the crosswalk the pedestrian will be crossing. If the object prediction is that a police officer is waving the AV to go around a stalled car, the plurality of actions may include different trajectories for the AV to move in the direction as indicated by the police officer.

In some instances, each of the plurality of actions can be generated at least in part from logic or policies associated with rules or laws for navigating a road. The rules or laws can include traffic rules, right of way rules, and other rules or laws associated driving on a road.

Selected AV actions can be removed from the plurality of actions based on collision avoidance analysis at step 930. In some instances, each of the plurality of actions are analyzed to determine if there is risk resulting in a collision with another object in the external environment. For any of the plurality of actions that are associated with a risk of collision, for example have a collision score that is greater than a certain threshold, such as 40%, those actions are removed from the plurality of actions generated at step 920.

The remaining actions are scored at step 940. Scoring the actions may include assigning a score based on the comfort to the user, the inconvenience caused two other vehicles or objects, the acceleration or deceleration required, the likelihood that an action will communicate and intention of the AV to perform an action, and other factors associated with each of the plurality of actions. In some instances, one or more factors may be weighted more than other factors, as configured by default, set by a user, or otherwise determined. The highest scored action of the remaining actions of FIG. 940 is selected at step 950. The highest scoring action is selected as the action to take by the AV.

The method steps of FIGS. 6-9 are provided in an exemplary order. It is intended that any of the steps can be performed in a different order, be split into multiple steps or combined with other steps, be performed serially or in parallel with other steps. Also, each of the methods of FIGS. 6-9 can include additional or fewer steps than those illustrated. The methods of FIGS. 6-9 can each be performed by processing logic that may comprise hardware (e.g., decision making logic, dedicated logic, programmable logic, and microcode), software (such as software run on a general-purpose computer system or a dedicated machine), or a combination of both.

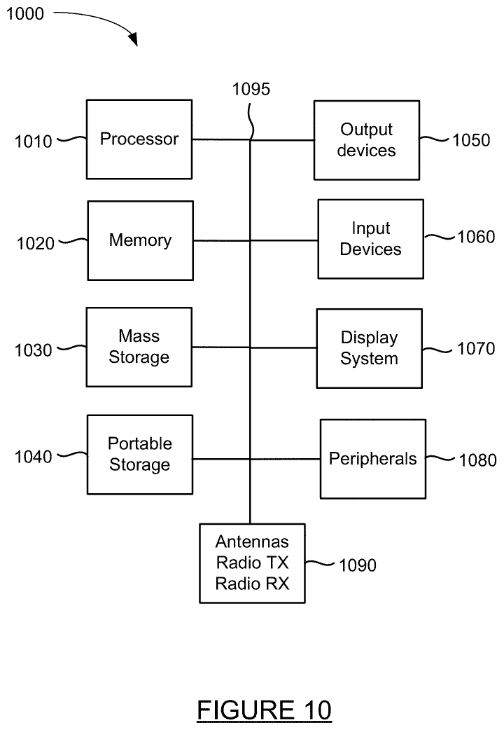

FIG. 10 is a block diagram of a computing environment for implementing a system for AV active interaction with surrounding environment for improved safety and efficiency. System 1000 of FIG. 10 can be implemented in the contexts a machine that implements an active interaction module of an AV. The computing system 1000 of FIG. 10 includes one or more processors 1010 and memory 1020. Main memory 1020 stores, in part, instructions, and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components can be connected through one or more data transport means. For example, processor unit 1010 and main memory 1020 can be connected via a local microprocessor bus, and the mass storage device 1030, peripheral device(s) 1080, portable storage device 1040, and display system 1070 can be connected via one or more input/output (I/O) buses.

Mass storage device 1030, which can be implemented with a magnetic disk drive, an optical disk drive, a flash drive, SSD drive, or other device, is a non-volatile storage device for storing data and instructions for use by processor unit 1010. Mass storage device 1030 can store the system software for implementing embodiments of the present technology for purposes of loading that software into main memory 1020.

Portable storage device 1040 operates in conjunction with a portable non-volatile storage medium, such as a flash drive, USB drive, memory card or stick, or other portable or removable memory, to input and output data and code to and from the computer system 1000 of FIG. 10. The system software for implementing embodiments of the present technology can be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, a pointing device such as a mouse, a trackball, stylus, cursor direction keys, microphone, touch-screen, accelerometer, a wireless device connected via radio frequency, a motion sensing device, and other input devices. Additionally, the system 1000 as shown in FIG. 10 includes output devices 1050. Examples of suitable output devices include speakers, printers, network interfaces, speakers, and monitors.

Display system 1070 may include a liquid crystal display (LCD) or other suitable display devices. Display system 1070 receives textual and graphical information and processes the information for output to the display device. Display system 1070 may also receive input as a touch-screen.

Peripherals 1080 may include any type of computer support device to add additional functionality to the computer system. For example, peripheral device(s) 1080 may include a modem or a router, printer, and other devices.

The system of 1000 may also include, in some implementations, antennas, radio transmitters and radio receivers 1090. The antennas and radios can be implemented in devices such as smartphones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1000 of FIG. 10 are those typically found in computer systems that can be suitable for use with embodiments of the present invention and are intended to represent a broad category of such computer components that are well known in the art. Thus, the computer system 1000 of FIG. 10 can be a personal computer, handheld computing device, smartphone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

The detailed description of embodiments described herein includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

1. An autonomous vehicle system for automatically interacting with a surrounding environment, the system comprising:
a data processing system comprising one or more processors, a memory, a planning module, and a control module, the data processing system to:
detect, from received sensor data, an object in an interaction scenario in an external environment;
monitor the object in response to the detecting the interaction scenario;
determine an intention for the object within the external environment based on the monitoring, wherein the intention is determined based on detected object gestures and a detected object state;
generating an object prediction based on the determined object intention and the detected object state; and
generate one or more commands to indicate an intention of the autonomous vehicle in response to the generated prediction of the object.

2. The system of claim 1, the data processing system further to:
predict an action of the object based on the determined intention of the object; and
determine an action to indicate the intention of the autonomous vehicle to the object, the one or more commands generated to implement the action.

3. The system of claim 1, the data processing system further to:
detect the interaction scenario based on the received sensor data; and
monitor an activity of the object within the interaction scenario.

4. The system of claim 1, wherein the object includes a pedestrian or a vehicle.

5. The system of claim 1, wherein the intention of the object is determined at least in part based on gestures performed by the object and detected by the data processing system.

6. The system of claim 1, wherein the received sensor data include semantic information to describe the object.

7. The system of claim 1, wherein the received sensor data includes one or more of the following: a vehicle location, a vehicle action, a pedestrian location, and a pedestrian action.

8. The system of claim 1, wherein the data processing system is further configured to select the intention of the autonomous vehicle based on the current object state.

9. The system of claim 1, wherein the autonomous vehicle is configured to signal the intention via at least one of the following: a visual indication, an audio indication, and a Vehicle-to-everything (V2X) communication.

10. The system of claim 1, wherein the interaction of the autonomous vehicle is determined at least in part on policies associated with traffic rules.

11. The system of claim 1, wherein the intention of the object is determined at least in part based on gestures performed by the object and detected by the data processing system.

12. A method for automatically interacting with a surrounding environment by an autonomous vehicle, the method comprising:
detecting, by a data processing system from received sensor data, an object in an interaction scenario in an external environment;
monitoring the object in response to the detecting the interaction scenario;
determine an intention for the object within the external environment based on the monitoring, wherein the intention is determined based on detected object gestures and a detected object state;
generating an object prediction based on the determined object intention and the detected object state; and
generate one or more commands to indicate an intention of the autonomous vehicle in response to the generated prediction of the object.

13. The method of claim 12, the data processing system further to:
predict an action of the object based on the determined intention of the object; and
determine an action to indicate the intention of the autonomous vehicle to the object, the one or more commands generated to implement the action.

14. The method of claim 12, the data processing system further to:
detect the interaction scenario based on the received sensor data; and
monitor an activity of the object within the interaction scenario.

15. The method of claim 12, wherein the object includes a pedestrian or a vehicle.

16. The method of claim 12, wherein the intention of the object is determined at least in part based on gestures performed by the object and detected by the data processing system.

17. The method of claim 12, wherein the received sensor data include semantic information to describe the object.

18. The method of claim 12, wherein the received sensor data includes one or more of the following: a vehicle location, a vehicle action, a pedestrian location, and a pedestrian action.

20. A non-transitory computer readable storage medium having embodied thereon a program, the program being executable by a processor to perform a method for automatically interacting with a surrounding environment by an autonomous vehicle, the method comprising:
detecting, by a data processing system from received sensor data, an object in an interaction scenario in an external environment;
monitoring the object in response to the detecting the interaction scenario;
determine an intention for the object within the external environment based on the monitoring, wherein the intention is determined based on detected object gestures and a detected object state;
generating an object prediction based on the determined object intention and the detected object state; and
generate one or more commands to indicate an intention of the autonomous vehicle in response to the generated prediction of the object.
